(19) United States
(12) Patent Application Publication
(10) Pub. No.: US 2014/0028203 A1
(43) Pub. Date: Jan. 30, 2014

(54) LED DRIVER CIRCUIT

(71) Applicant: LUXUL TECHNOLOGY INCORPORATION, New Taipei City (TW)

(72) Inventors: Cheng-Hung PAN, New Taipei City (TW); Perng-Fei YUH, New Taipei City (TW)

(21) Appl. No.: 13/942,997

(22) Filed: Jul. 16, 2013

(30) Foreign Application Priority Data
Jul. 30, 2012 (TW) 101127426

(51) Int. Cl. H05B 33/08

(52) U.S. Cl. CPC H05B 33/0818
USPC 315/186

(57) ABSTRACT

A high efficiency AC LED driver circuit has a rectifier unit, an LED light string, multiple voltage controlled transistors, a current detection unit, and a power efficiency control unit. The rectifier unit is connected to an AC power and converts the AC power into a pulsating DC power. The LED light string is connected to the rectifier unit and has multiple LED units. The voltage controlled transistors are respectively and electrically connected to each LED unit and form multiple shunt circuits. The current detection unit is electrically connected to the voltage controlled transistors. The power efficiency control unit is electrically connected to the current detection unit, series nodes between the LED units and the control terminals of the voltage controlled transistors; wherein the power efficiency control unit adjusts loop current based on a voltage drop of each LED unit.

### CROSS-REFERENCE TO RELATED APPLICATIONS

This application claims the benefit of Taiwan patent application No. 101127426, filed on Jul. 30, 2012, the disclosure of which is incorporated herein in its entirety by reference.

### BACKGROUND OF THE INVENTION

1. Field of the Invention

The present invention relates to an LED driver circuit and more particularly to a high efficiency AC LED driver circuit.

2. Description of Related Art

Electrical transmission is usually in AC nowadays, because AC electrical transmission is more efficient than DC electrical transmission. A voltage of the AC power transmitted from a power plant to each family is 110V or 220V. However, the voltage of the AC power received by users is usually not that ideal but has some error. In general, an error range of the AC power is +/−10%. For example, a tolerance range of an 110V AC power is between 99V and 122V.

LEDs are common lighting appliances nowadays. Compared to conventional incandescent bulbs, LEDs have advantages of higher luminous efficiency and lower power consumption. However, LEDs can only be conducted in a one-way circuit such that LEDs cannot be connected to a conventional AC outlet. Therefore, an AC LED driver circuit is invented. With reference to FIG. 5, the conventional AC LED driver circuit has:

a rectifier unit 60 having an input terminal and an output terminal; wherein the input terminal is connected to an AC power AC/IN and converts the AC power AC/IN into a pulsating DC power outputted by the output terminal;

an LED unit 61 having multiple LED sources and connected to the output terminal of the rectifier unit 60 to form a power loop;

a voltage controlled transistor 62 having a control terminal and connected in series with the power loop; wherein the voltage controlled transistor controls currents flowing in the power loop;

a current detection unit 63 connected in series with the power loop to obtain a loop current value of the power loop; and

a control unit 64 having a built-in reference current value, electrically connected to the current detection unit 63 through a low-frequency filter and electrically connected to the control terminal of the voltage controlled transistor 62; wherein the control unit 64 obtains the loop current value from the current detection unit 63, the control unit 64 compares the loop current value with the reference current value, and then feedback controls the loop current of the power loop based on a comparison result of the loop current value and the reference current value through the voltage controlled transistor 62.

In conclusion, a user can control the loop current flowing through the LED unit 61 by setting or adjusting the reference current value of the control unit 64 to further control an output power and a luminance of the LED unit 61 by the loop current.

However, the voltage of the AC power AC/IN outputted by the power plant is not stable; thus, a means of stabilizing the loop current is adopted in a conventional AC LED driver circuit to prevent same products from having difference degrees of luminance due to the instability or error of the AC power AC/IN. For example, if a voltage between two ends of the LED unit 61 is 80V and a power of 12.8 W is needed to achieve a desired luminance, the user just sets the reference current value as 160 mA to fix the loop current at 160 mA to further achieve an objective of fixing the output power of the LED unit 61 at 12.8 W.

With reference to FIG. 6, the means of stabilizing the loop current adopted in the conventional AC LED driver circuit can keep the LED unit 61 outputting at a specific power, but the efficiency is decreased with the increasing of the voltage of the AC power AC/IN. Continuing the above example, if the voltage of the AC power AC/IN is 99V and the loop current is 160 mA, an input power is 15.84 W. Compared to the output power of the LED unit 61 (12.8 W), the efficiency can be obtained as 80.81%; if the voltage of the AC power AC/IN is increased to 122V, the input power is 19.52 W, but the efficiency is decreased to 65.57%. According to the above description, the efficiency of the conventional AC LED driver circuit is decreased with the increasing of the voltage of the AC power AC/IN.

To investigate the reason, according to the power equation (input power Pᵢₙ=output power Pₒᵤₜ+lost power Pₗₒₛₑ) and the efficiency equation (efficiency η=output power Pₒᵤₜ/input power Pᵢₙ), the main reason of the decrease of the efficiency of the conventional AC LED driver circuit is that the output power of the LED unit 61 is not increased with the increasing of the input power Pᵢₙ, that is, the lost power Pₗₒₛₑ is increased with the input power Pᵢₙ. Therefore, a better solution must be provided to solve the above-mentioned problem.

### SUMMARY OF THE INVENTION

The main objective of the invention is to provide a high efficiency AC LED driver circuit.

The LED driver circuit comprises:

a rectifier unit having an input terminal and an output terminal; wherein the input terminal is connected to an AC power and the rectifier unit converts the AC power into a pulsating DC power outputted by the output terminal;

an LED light string connected to the rectifier unit and having multiple LED units connected in series; wherein each LED unit has an anode terminal and a cathode terminal;

multiple voltage controlled transistors respectively and electrically connected to the cathode terminals of the LED units to form multiple hierarchical shunt circuits; wherein each voltage controlled transistor has a control terminal;

a current detection unit electrically connected to the voltage controlled transistors, and forming a power loop with the rectifier unit, the LED light string and the voltage controlled transistors; wherein the current detection unit is used to detect a current flowing through the power loop, and the current flowing through the power loop is a sum of currents flowing through the shunt circuits; and

a power efficiency control unit electrically connected to the current detection unit, series nodes between the LED units, and the control terminals of the voltage controlled transistors; wherein the power efficiency control unit obtains a voltage drop of each series node between the LED units, and then adjusts current intensity of a current flowing through each shunt circuit based on a voltage drop of each LED unit.

When the AC power increases, the power efficiency control unit adjusts a current flowing through each shunt circuit by each voltage controlled transistor to distribute an increased lost power Pₗₒₛₑ of each voltage controlled transistor caused by the increase of the voltage of the AC power to each LED unit, and each LED unit consumes the lost power Pₗₒₛₑ such that the lost power Pₗₒₛₑ is converted to the output power Pₒᵤₜ. Therefore, lost power Pₗₒₛₑ of each voltage controlled transistor is decreased and output power Pₒᵤₜ of each LED unit is increased to achieve the objective of increasing the whole efficiency of the LED driver circuit.

### BRIEF DESCRIPTION OF THE DRAWINGS

FIG. 1 is a circuit diagram of a first embodiment of an LED driver circuit in accordance with the present invention;

FIG. 2 shows characteristic curves of the LED driver circuit in FIG. 1;

FIG. 3A is an operational schematic view of the LED driver circuit in FIG. 1;

FIG. 3B is another operational schematic view of the LED driver circuit in FIG. 1;

FIG. 3C is another operational schematic view of the LED driver circuit in FIG. 1;

FIG. 4 is a circuit diagram of a second embodiment of an LED driver circuit in accordance with the present invention;

FIG. 5 is a circuit diagram of a conventional LED driver; and

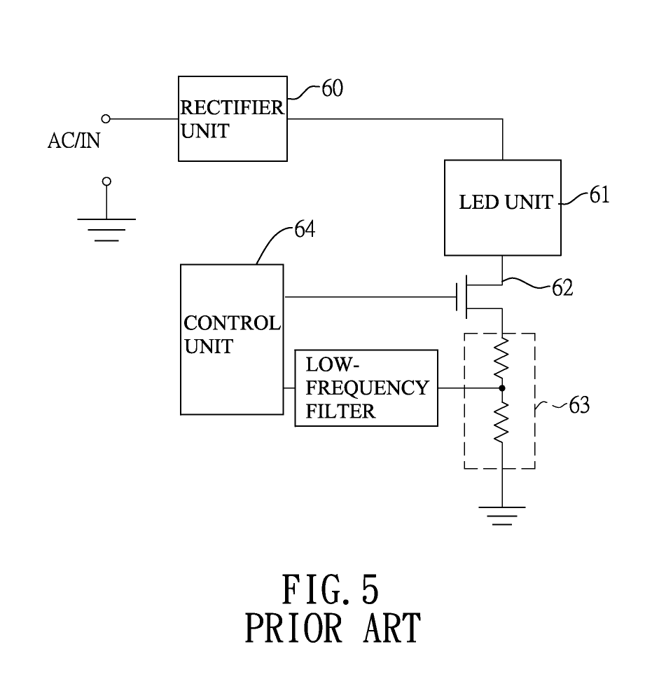

FIG. 6 shows characteristic curves of the LED driver circuit in FIG. 5.

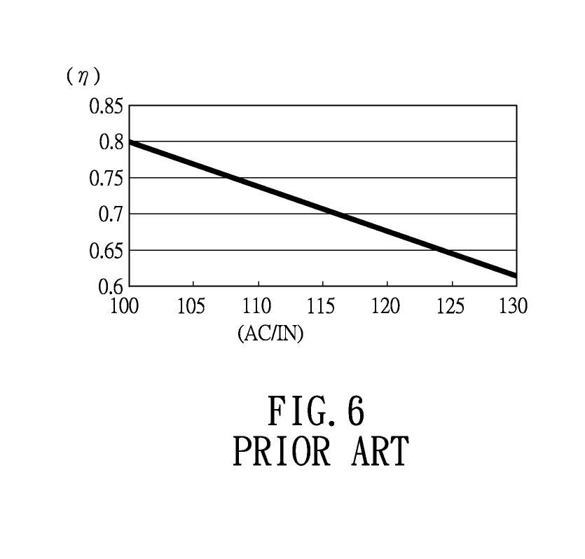

### DETAILED DESCRIPTION OF THE PREFERRED EMBODIMENTS

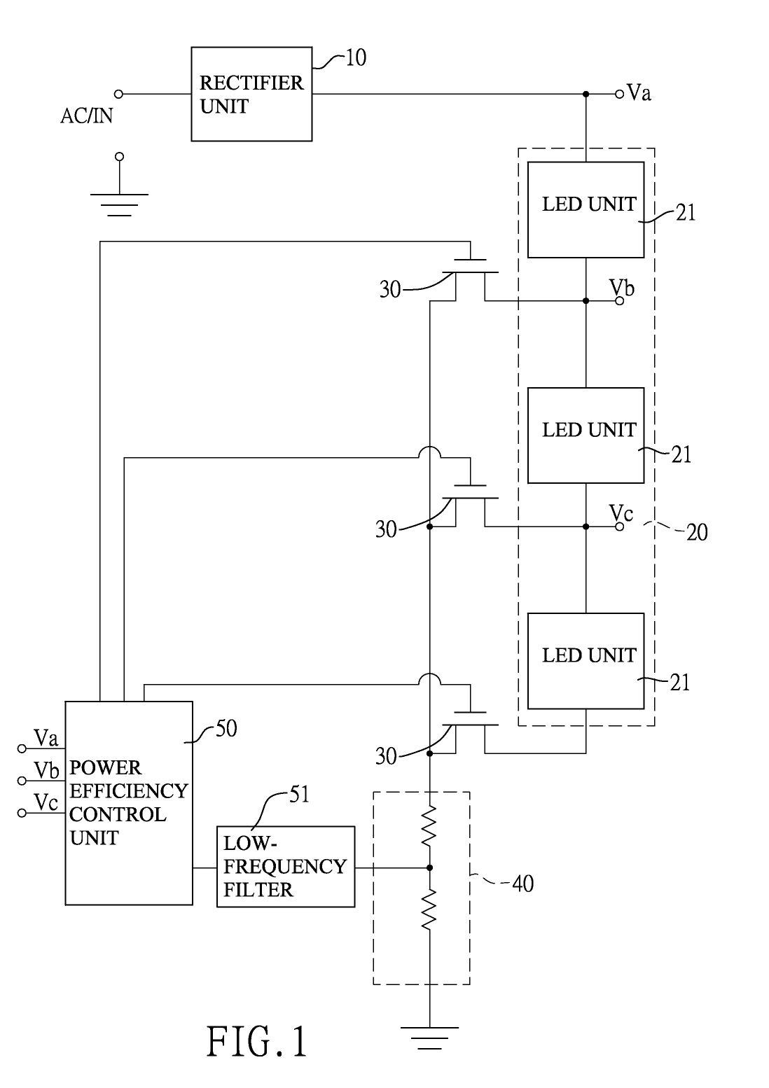

With reference to FIG. 1, a preferred embodiment of an LED driver circuit in accordance with the present invention comprises:

a rectifier unit 10 having an input terminal and an output terminal; wherein the input terminal is connected to an AC power AC/IN and the rectifier unit 10 converts the AC power AC/IN into a pulsating DC power outputted by the output terminal; in a preferred embodiment, the rectifier unit 10 is a full-wave rectifier circuit or a half-wave rectifier circuit;

an LED light string 20 connected to the rectifier unit 10 and having multiple LED units 21 connected in series; wherein each LED unit 21 has an anode terminal and a cathode terminal; in a preferred embodiment, each LED unit 21 has multiple LED sources, each LED source is connected in series, parallel or series-parallel with another LED source in a same LED unit 21;

multiple voltage controlled transistors 30 respectively and electrically connected to the cathode terminals of LED units 21 and forming multiple hierarchical shunt circuits; wherein each voltage controlled transistor 30 has a control terminal; in a preferred embodiment, each of the voltage controlled transistors 30 is a MOSFET, a JFET or a BJT, and the control terminal is a gate of the above-mentioned transistors;

a current detection unit 40 electrically connected to the voltage controlled transistors 30, and forming a power loop with the rectifier unit 10, the LED light string 20 and the voltage controlled transistors 30; wherein the current detection unit 40 is used to detect a current flowing through the power loop; the current flowing through the power loop is a sum of currents flowing through the shunt circuits; in a preferred embodiment, the current detection unit 40 is a detection resistor; and

a power efficiency control unit 50 electrically connected to the current detection unit 40, series nodes between the LED units 21, and the control terminals of the voltage controlled transistors 30; wherein the power efficiency control unit 50 obtains a voltage drop of each series node between the LED units 21, and then adjusts current intensity of a current flowing through each shunt circuit based on a voltage drop of each LED unit 21; in a preferred embodiment, the power efficiency control unit 50 is electrically connected to the current detection unit 40 through a low-frequency filter 51 and the low-frequency filter 51 is a analog filter or a digital filter; the digital filter can be a down-sampling filter.

When a user uses the LED driver circuit, the user first conducts a first shunt circuit of the power efficiency control unit 50. When voltage drops between the LED units 21 are increased with increase of voltage of the AC power AC/IN, the user gradually decreases a current flowing through the first shunt circuit and gradually increases a current flowing through a second shunt circuit. When the voltage of the AC power AC/IN is decreased such that the voltage drops between the LED units 21 are decreased, the user gradually decreases the current flowing through a lower shunt circuit and gradually increases the current flowing through an upper shunt circuit.

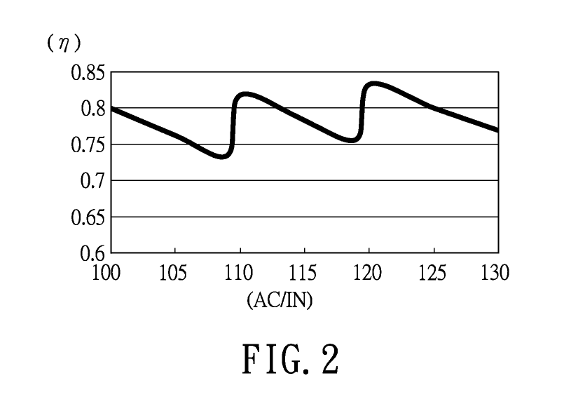

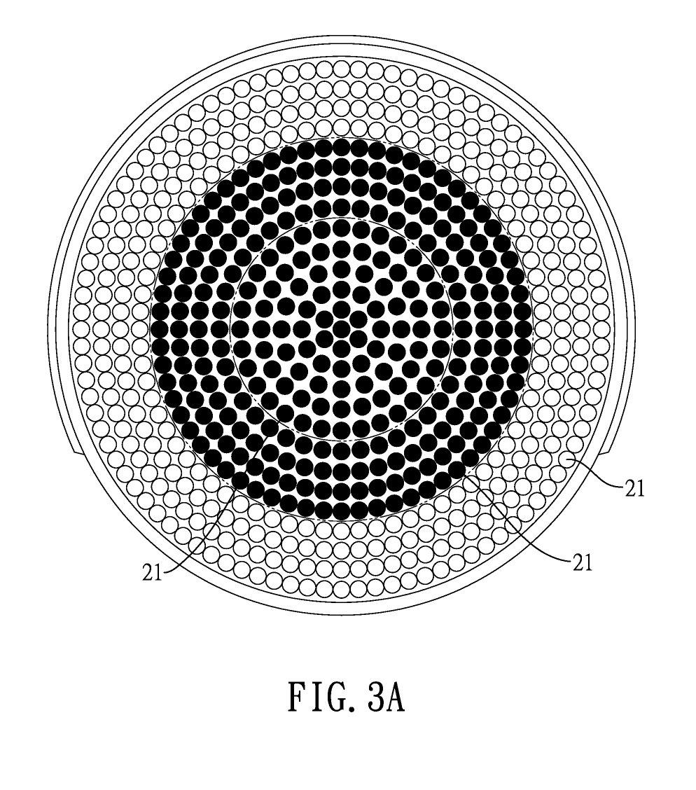

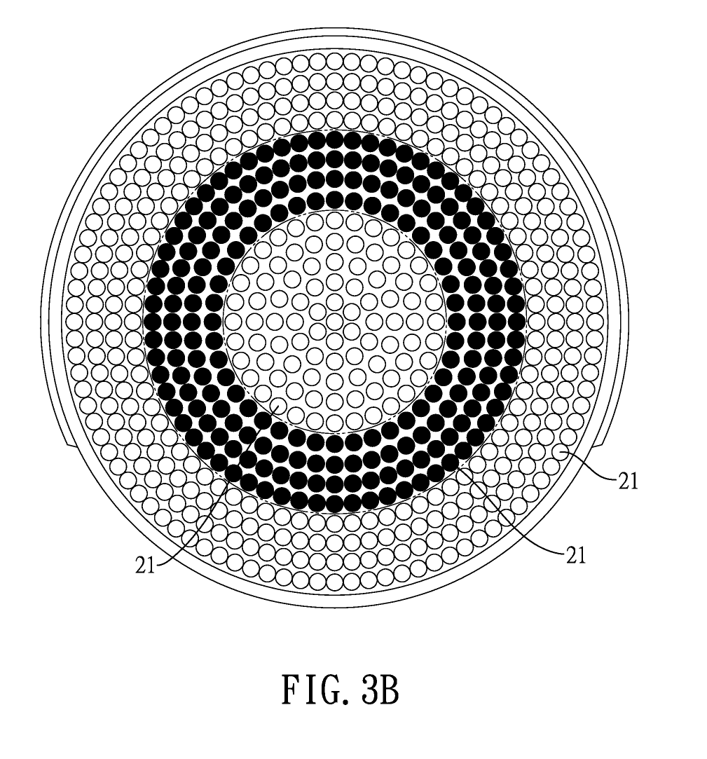

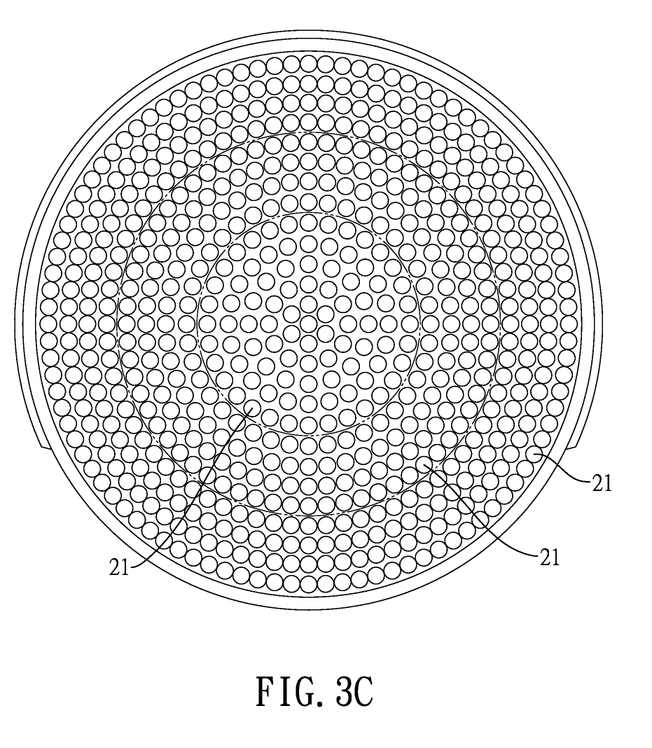

With Further reference to FIG. 2, the LED string has three LED units, and cut-in voltages of the LED units are respectively 80V, 10V and 10V from the first to the third shunt circuits, and the loop current is fixed at 160 mA by the power efficiency control unit 50. If the voltage of the AC power AC/IN is under 110V, with further reference to FIG. 3A, the power efficiency control unit 50 only conducts the first shunt circuit and the other shunt circuits are not conducted. The loop current only flows through the first LED unit. Therefore, efficiency of the LED driver circuit is decreased from 80% to 73.39% when the voltage of the AC power AC/IN is increased from 100V to 109V. When the voltage of the AC power AC/IN is between 110V to 119V, with further reference to FIG. 3B, the current flowing through the first shunt circuit is adjusted to 0 A and the current flowing through the second shunt circuit is adjusted to 160 mA by the power efficiency control unit 50. The loop current flows through the first and the second LED units and the efficiency of the LED driver circuit is increased to 81.81% at the moment of the second LED unit working and then is gradually decreased to 75.63%. When the voltage of the AC power AC/IN is higher than 120V, with further reference to FIG. 3C, the current flowing through the second shunt circuit is adjusted to 0 A and the current flowing through the third shunt circuit is adjusted to 160 mA by the power efficiency control unit 50. The loop current flows through all LED units 21 and the efficiency of the LED driver circuit is increased to 83.33% and then is gradually decreased.

Therefore, when the voltage of the AC power AC/IN is increased, the power efficiency control unit 50 adjusts a current flowing through each shunt circuit by each voltage controlled transistor to distribute an increased lost power Pₗₒₛₑ of each voltage controlled transistor 30 caused by the increase of the voltage of the AC power AC/IN to each LED unit 21, and each LED unit 21 consumes the lost power Pₗₒₛₑ such that the lost power Pₗₒₛₑ is converted to the output power Pₒᵤₜ. Therefore, lost power Pₗₒₛₑ of each voltage controlled transistor 30 is decreased and output power Pₒᵤₜ of each LED unit 21 is increased to achieve the objective of increasing the whole efficiency of the LED driver circuit.

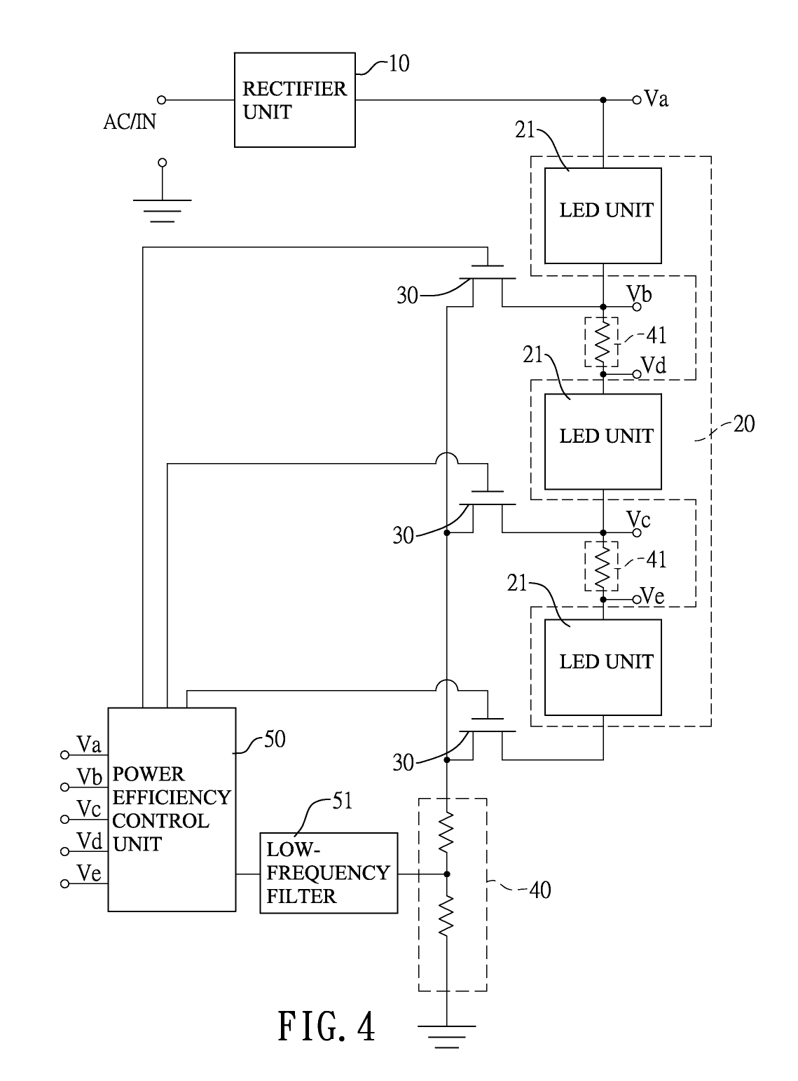

In addition, with reference to FIG. 4, a second preferred embodiment is shown; the circuit structure is substantially similar to the above-mentioned embodiment. A difference between the first and the second embodiments is that the second embodiment further includes two shunt detection units 41. The two shunt detection units 41 are respectively connected in series between each two adjacent LED units 21. The shunt detection units 41 are connected to the power efficiency control unit 50 to detect a current flowing through a corresponding LED unit 21. The power efficiency control unit 50 multiples a voltage drop and a current of each LED unit 21 to obtain power of each LED unit 21. The efficiency control unit 50 adjusts current intensity of a current flowing through each shunt circuit based on the power of each LED unit 21.

According to the above description, when power of the multiple LED units 21 is increased with increase of the AC power AC/IN, the power efficiency control unit 50 gradually adjusts current intensity of a current flowing through each shunt circuit by each voltage controlled transistor 30 to decrease the loop current, that is, the original input power Pᵢₙ prior to the increase of the AC power AC/IN is maintained after the AC power AC/IN is increased. Therefore, the original output power Pₒᵤₜ prior to the increase of the AC power AC/IN is also maintained after the AC power AC/IN is increased.

Hence, when the input power Pᵢₙ is temporarily increased due to the increase of the AC power AC/IN, the LED driver circuit decreases the loop current to maintain the original input power Pᵢₙ after the AC power AC/IN is increased. The LED driver circuit further adjusts a current flowing through each shunt circuit to maintain the original output power Pₒᵤₜ after the AC power AC/IN is increased. When the input power Pᵢₙ and the output power Pₒᵤₜ are both unchanged, the efficiency of the LED driver circuit must not be changed.

In conclusion, the LED driver circuit solves a problem of decreased efficiency and further keeps the efficiency at a high point.

What is claimed is:

1. A high efficiency AC LED driver circuit comprising:
a rectifier unit having an input terminal and an output terminal; wherein the input terminal is connected to an AC power and the rectifier unit converts the AC power into a pulsating DC power outputted by the output terminal;
an LED light string connected to the rectifier unit and having multiple LED units connected in series; wherein each LED unit has an anode terminal and a cathode terminal;
multiple voltage controlled transistors respectively and electrically connected to the cathode terminals of the LED units to form multiple hierarchical shunt circuits; wherein each voltage controlled transistor has a control terminal;
a current detection unit electrically connected to the voltage controlled transistors, and forming a power loop with the rectifier unit, the LED light string and the voltage controlled transistors; wherein the current detection unit is used to detect a current flowing through the power loop, and the current flowing through the power loop is a sum of currents flowing through the shunt circuits; and
a power efficiency control unit electrically connected to the current detection unit, series nodes between the LED units, and the control terminals of the voltage controlled transistors; wherein the power efficiency control unit obtains a voltage drop of each series node between the LED units, and then adjusts current intensity of a current flowing through each shunt circuit based on a voltage drop of each LED unit.

2. The LED driver circuit as claimed in claim 1 further comprising at least one shunt detection unit; wherein each one of the at least one shunt detection unit is connected in series between each two adjacent LED units; the at least one shunt detection unit is connected to the power efficiency control unit to detect a current flowing through a corresponding LED unit; the power efficiency control unit multiples a voltage drop and a current of each LED unit to obtain power of each LED unit; the efficiency control unit adjusts the current intensity of the current flowing through each shunt circuit based on the power of each LED unit.

3. The LED driver circuit as claimed in claim 1, wherein the power efficiency control unit is electrically connected to the current detection unit through a low-frequency filter.

4. The LED driver circuit as claimed in claim 2, wherein the power efficiency control unit is electrically connected to the current detection unit through a low-frequency filter.

5. The LED driver circuit as claimed in claim 3, wherein the low-frequency filter is an analog filter.

6. The LED driver circuit as claimed in claim 4, wherein the low-frequency filter is an analog filter.

7. The LED driver circuit as claimed in claim 3, wherein the low-frequency filter is a digital filter.

8. The LED driver circuit as claimed in claim 4, wherein the low-frequency filter is a digital filter.

9. The LED driver circuit as claimed in claim 7, wherein the digital filter is a down-sampling filter.

10. The LED driver circuit as claimed in claim 8, wherein the digital filter is a down-sampling filter.

11. The LED driver circuit as claimed in claim 7, wherein each of the voltage controlled transistors is a MOSFET.

12. The LED driver circuit as claimed in claim 8, wherein each of the voltage controlled transistors is a MOSFET.

13. The LED driver circuit as claimed in claim 7, wherein each of the voltage controlled transistors is a JFET.

14. The LED driver circuit as claimed in claim 8, wherein each of the voltage controlled transistors is a JFET.

15. The LED driver circuit as claimed in claim 7, wherein each of the voltage controlled transistors is a BJT.

16. The LED driver circuit as claimed in claim 8, wherein each of the voltage controlled transistors is a BJT.

17. The LED driver circuit as claimed in claim 7, wherein the rectifier unit is a full-wave rectifier circuit.

18. The LED driver circuit as claimed in claim 8, wherein the rectifier unit is a full-wave rectifier circuit.

19. The LED driver circuit as claimed in claim 7, wherein the rectifier unit is a half-wave rectifier circuit.

20. The LED driver circuit as claimed in claim 8, wherein the rectifier unit is a half-wave rectifier circuit.
